(19) United States
(12) Patent Application Publication
(10) Pub. No.: US 2024/0347236 A1
(43) Pub. Date: Oct. 17, 2024

(54) MOV/GDT DEVICE HAVING LOW VOLTAGE GAS DISCHARGE PROPERTY

(71) Applicant: Bourns, Inc., Riverside, CA (US)

(72) Inventors: Oscar ULLOA ESQUIVEL, Heredia (CR); Kelly C. CASEY, Corinth, TX (US); Gordon L. BOURNS, Riverside, CA (US)

(21) Appl. No.: 18/755,575

(22) Filed: Jun. 26, 2024

Related U.S. Application Data
(63) Continuation of application No. PCT/US2022/054151, filed on Dec. 28, 2022.
(60) Provisional application No. 63/294,795, filed on Dec. 29, 2021.

(51) Int. Cl. H01C 1/02; H01C 7/10; H01C 17/00

(52) U.S. Cl. CPC H01C 1/02; H01C 7/10; H01C 17/00

(57) ABSTRACT

Electrical devices can be manufactured with a number of metal oxide varistors (MOVs) with each MOV including an external electrode on a first side of a metal oxide layer and an internal electrode on a second side of the metal oxide layer, and a layer of sealing material at or near a perimeter of the second side of the metal oxide layer of each MOV. A stack having one or more pairs can be provided, with each pair including two MOVs with their second sides facing each other such that the respective layers of sealing material engage each other, and the engaged layers can be fused to result in a seal that provides a sealed chamber of a gas discharge tube (GDT) between the two internal electrodes of each pair, with the seal having a thickness that is approximately same as a selected gap dimension between the two internal electrodes.

### CROSS-REFERENCE TO RELATED APPLICATION(S)

This application is a continuation of International Application No. PCT/US2022/054151 filed Dec. 28, 2022, entitled MOV/GDT DEVICE HAVING LOW VOLTAGE GAS DISCHARGE PROPERTY, which claims priority to U.S. Provisional Application No. 63/294,795 filed Dec. 29, 2021, entitled MOV/GDT DEVICE HAVING LOW VOLTAGE GAS DISCHARGE PROPERTY, the benefits of the filing dates of which are hereby claimed and the disclosures of which are hereby expressly incorporated by reference herein in their entirety.

### BACKGROUND

### Field

The present disclosure relates to gas discharge tube (GDT) based devices having low voltage gas discharge property.

### Description of the Related Art

A gas discharge tube (GDT) is a device having a gas between two electrodes in a sealed chamber. When a triggering condition arises between the electrodes, the gas ionizes and conducts electricity between the electrodes.

A metal oxide varistor (MOV) includes a metal oxide material, such as zinc oxide, implemented between two electrodes. Under normal condition, the MOV is non-conducting, but becomes conducting when the voltage exceeds the rated voltage.

It is noted that a typical MOV by itself can degrade due to, for example, a constant AC line voltage stress. Such a stress can result from surge history, time, temperature, or some combination thereof, and result in an increase in leakage current, and/or a decrease in effectiveness of the MOV. The increase in leakage current can negatively impact an energy efficiency rating of the MOV due to an increase in a stand-by current. Also, sustained AC voltage swells can result in overheating of the MOV which in turn can result in failure and/or fire.

When an MOV is combined with a GDT, the resulting combination can be a GDT/MOV device having a GDT and an MOV electrically connected in series. When operating under normal conditions, a line voltage appears largely across the GDT, thereby effectively disconnecting the MOV from the line. During a surge event, the GDT can switch on relatively quickly, and thereby connect the MOV across the line to clamp the surge voltage to an acceptable level. Once the surge event has passed, the GDT can switch off again and thereby disconnect the MOV as before.

Accordingly, a GDT/MOV device can provide a number of advantageous features. For example, reduced leakage current in the MOV portion can be achieved, which can extend the operating life of the device. In another example, a GDT/MOV device can be designed to provide voltage swell immunity, or reduced sensitivity to such a voltage swell, without sacrificing clamping voltage performance.

### SUMMARY

In some implementations, the present disclosure relates to a method for manufacturing a plurality of electrical devices. The method includes forming or providing a number of metal oxide varistors (MOVs) such that each MOV includes an external electrode on a first side of a metal oxide layer and an internal electrode on a second side of the metal oxide layer, and forming a layer of sealing material at or near a perimeter of the second side of the metal oxide layer of each MOV. The method further includes forming a stack having one or more pairs, with each pair including two MOVs with their second sides facing each other such that the respective layers of sealing material engage each other. The method further includes performing a sealing operation to fuse the engaged layers of sealing material to result in a seal that provides a sealed chamber of a gas discharge tube (GDT) between the two internal electrodes of each pair. The sealing operation is performed such that the seal has a thickness dimension that is approximately same as a selected gap dimension between the two internal electrodes.

In some embodiments, the forming of the layer of sealing material results in a thickness of the layer of sealing material of one of the two MOVs of each pair being substantially same as a thickness of the layer of sealing material of the other of the two MOVs of the pair.

In some embodiments, the sealing material can include glass or other high temperature insulative sealing material.

In some embodiments, the forming or providing of MOVs results in the external electrode of each MOV being substantially flat. In some embodiments, the forming or providing of MOVs results in the external electrode of each MOV having a flared edge configuration.

In some embodiments, the stack includes a plurality of pairs.

In some embodiments, the performing of the sealing operation includes providing a desired gas to the stack so that the desired gas is introduced to an unsealed chamber of each pair of MOVs. The desired gas can include an inert gas and/or an active gas. In some embodiments, the desired gas can include neon or argon. In some embodiments, the desired gas can include neon at approximately 500 torr.

In some embodiments, the method can further include forming an emissive coating on each internal electrode. The emissive coating can include glass or an active coating. In some embodiments, the emissive coating can include the active coating. In some embodiments, the active coating can include an alkali metal or alkali-based compound.

In some embodiments, the gap dimension between the two internal electrodes, the emissive coating and the desired gas can be selected to provide a breakdown voltage of the GDT that is less than 120V. In some embodiments, the breakdown voltage of the GDT can be less than 100V.

In some embodiments, the selected gap dimension between the two internal electrodes can be less than 500 μm. In some embodiments, the selected gap dimension between the two internal electrodes can be in a range between 250 μm and 300 μm. In some embodiments, the selected gap dimension between the two internal electrodes can be approximately 280 μm.

In some embodiments, the seal can include a laterally extending portion formed to cover a portion of each of either or both of the internal electrodes to increase a length of a leakage path between the internal electrodes. In some embodiments, the laterally extending portion can result from the sealing operation and/or from an extension of the sealing material formed prior to the sealing operation.

In some embodiments, the sealing operation can include providing a selected force on the stack to result in the thickness dimension of the seal of each pair.

In some implementations, the present disclosure relates to a system for manufacturing a plurality of electrical devices. The system includes a metal oxide varistor (MOV) fabrication system configured to form or provide a number of MOVs such that each MOV includes an external electrode on a first side of a metal oxide layer and an internal electrode on a second side of the metal oxide layer. The system further includes a gas discharge tube (GDT) fabrication system configured to form a layer of sealing material at or near a perimeter of the second side of the metal oxide layer of each MOV. The GDT fabrication system is further configured to form a stack having one or more pairs, with each pair including two MOVs with their second sides facing each other such that the respective layers of sealing material engage each other. The GDT fabrication system is further configured perform a sealing operation to fuse the engaged layers of sealing material to result in a seal that provides a sealed chamber of a GDT between the two internal electrodes of each pair, such that the seal has a thickness dimension that is approximately same as a selected gap dimension between the two internal electrodes.

In some implementations, the present disclosure relates to an electrical device that includes first and second metal oxide varistors (MOVs), with each MOV including an external electrode on a first side of a respective metal oxide layer and an internal electrode on a second side of the metal oxide layer. The electrical device further includes a seal at or near a perimeter of the second side of the metal oxide layer of each of the first and second MOVs to thereby provide a sealed chamber with a desired gas therein of a gas discharge tube (GDT) between the two internal electrodes of the first and second MOVs, with the seal having a thickness dimension that is approximately same as a selected gap dimension between the two internal electrodes.

In some embodiments, the seal includes glass or other high temperature insulative sealing material.

In some embodiments, the external electrode of each MOV can be substantially flat or have a flared edge configuration.

In some embodiments, the desired gas can include an inert gas and/or an active gas. In some embodiments, the desired gas can include neon or argon. In some embodiments, the desired gas can include neon at approximately 500 torr.

In some embodiments, the electrical device can further include an emissive coating on each internal electrode. In some embodiments, the emissive coating can include glass or an active coating.

In some embodiments, the emissive coating can include the active coating. In some embodiments, the active coating can include an alkali metal or alkali-based compound.

In some embodiments, the gap dimension between the two internal electrodes, the emissive coating and the desired gas can be selected to provide a breakdown voltage of the GDT that is less than 120V. The breakdown voltage of the GDT can be less than 100V.

In some embodiments, the selected gap dimension between the two internal electrodes can be less than 500 μm. In some embodiments, the selected gap dimension between the two internal electrodes can be in a range between 250 μm and 300 μm. In some embodiments, the selected gap dimension between the two internal electrodes can be, for example, approximately 280 μm.

In some embodiments, the seal can include a laterally extending portion formed to cover a portion of each of either or both of the internal electrodes to increase a length of a leakage path between the internal electrodes.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1A shows a side sectional view of a MOV/GDT device.

FIG. 1B shows an enlarged view of a seal portion of the MOV/GDT device of FIG. 1A.

FIGS. 2A and 2B show that in some embodiments, the MOV/GDT device of FIGS. 1A and 1B can have a rectangular lateral shape having an overall length dimension and an overall width dimension.

FIGS. 3A and 3B show that in some embodiments, the MOV/GDT device of FIGS. 1A and 1B can have a circular lateral shape having an overall diameter dimension.

FIGS. 4A to 4D show an example of how parts of MOV/GDT devices can be manufactured.

FIGS. 5A to 5C show an example of how MOV/GDT devices can be manufactured utilizing the parts produced in the example of FIGS. 4A to 4D.

FIG. 6A shows a stack having a plurality of un-sealed pairs prior to a sealing process.

FIG. 6B shows an enlarged view of one side of the stack of FIG. 6A.

FIG. 7 shows that in some embodiments, a selected force can be applied on the top of the stack of pairs in an un-sealed state.

FIG. 8 shows that in some embodiments, a force can be applied on top of the stack of pairs during a sealing process to yield a stack of sealed pairs, with each pair including a seal layer with a thickness dimension resulting from fusing of the two sealing layers.

FIG. 9 shows a MOV/GDT device having a GDT portion that is similar to the MOV/GDT device of FIG. 1A.

FIG. 10A shows a photograph of a sectional view of a seal portion of a MOV/GDT device having one or more features as described herein.

FIG. 10B depicts the seal portion of FIG. 10A, but with various dimensions similar to the example seal portion of FIG. 1B.

### DETAILED DESCRIPTION OF SOME EMBODIMENTS

The headings provided herein, if any, are for convenience only and do not necessarily affect the scope or meaning of the claimed invention.

Disclosed are examples related to an electrical device having a combination of a metal oxide varistor (MOV) and a gas discharge tube (GDT), where the GDT includes a low voltage functionality. For the purpose of description, such an electrical device is referred to herein as a MOV/GDT device or simply as a MOV/GDT. Examples related to such MOV/GDT devices are provided in International Publication No. WO 2021/174140A1, the disclosure of which is hereby expressly incorporated by reference herein in its entirety.

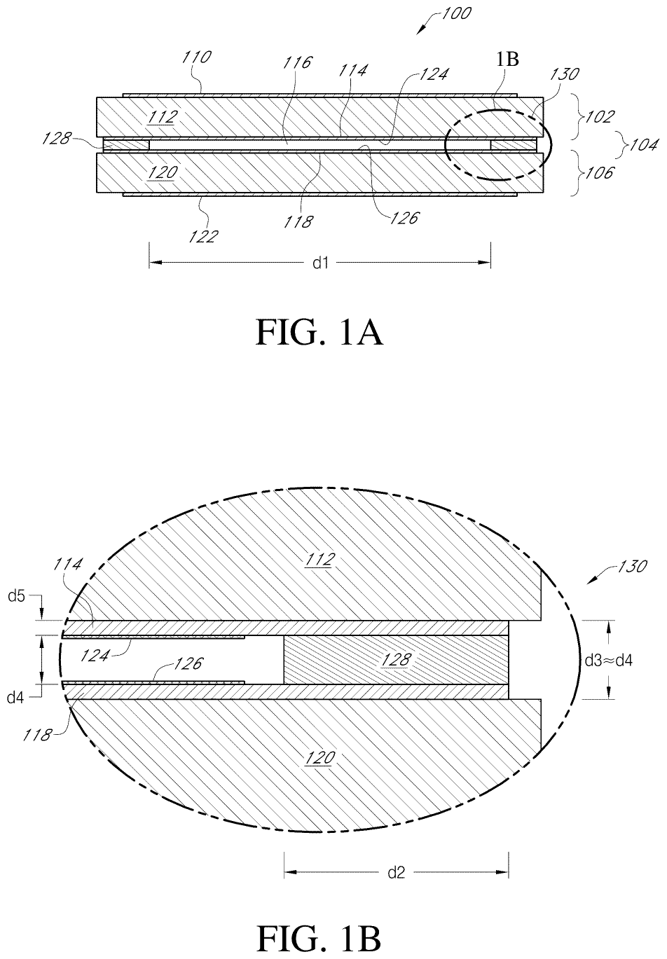

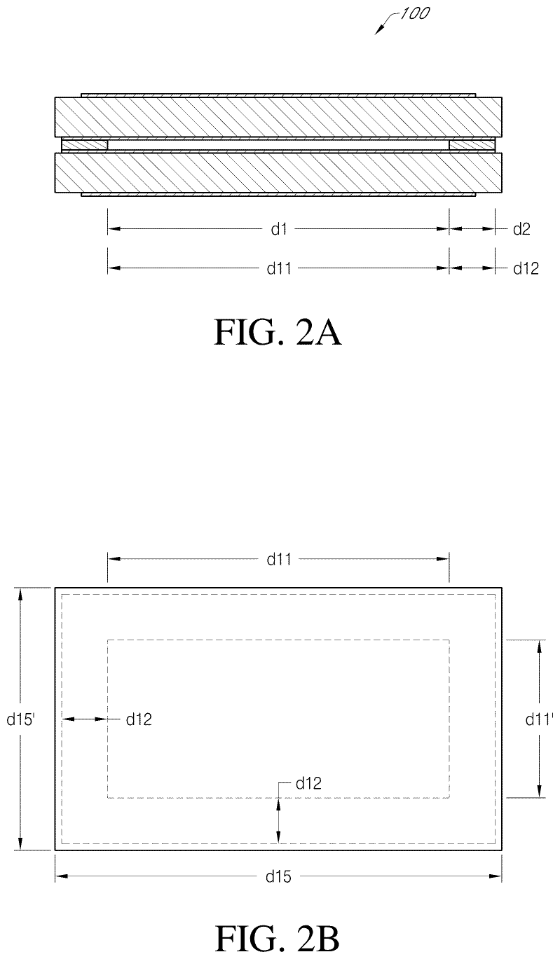

FIG. 1A shows a side sectional view of a MOV/GDT device 100 that includes a sealed chamber 116 having opposing sides. A first electrode 114 can be implemented on one of such opposing sides, and a second electrode 118 can be implemented on the other side, thereby providing a GDT configuration 104 (also referred to as a GDT herein). For the purpose of description, the foregoing first and second electrodes 114, 118 may also be referred to herein as internal electrodes, first and second internal electrodes, GDT electrodes, first and second GDT electrodes, or some combination thereof.

In the example of FIG. 1A, the first electrode 114 of the GDT 104 is also shown to function as one of two electrodes of a first MOV configuration 102 (also referred to as a MOV herein). More particularly, a metal oxide layer 112 is shown to be implemented between the first electrode 114 of the GDT 104 and a first external electrode 110, thereby providing the first MOV functionality. Similarly, the second electrode 118 of the GDT 104 is also shown to function as one of two electrodes of a second MOV configuration 106 (also referred to as a MOV herein). More particularly, a metal oxide layer 120 is shown to be implemented between the second electrode 118 of the GDT 104 and a second external electrode 122, thereby providing the second MOV functionality.

FIG. 1B shows an enlarged view of a seal portion 130 of the MOV/GDT device 100 of FIG. 1A. Referring to FIGS. 1A and 1B, the GDT 104 is shown to include a seal layer 128 formed from an electrically insulating material such as glass. Such a seal layer can be formed as described herein to yield a thickness d3 that is approximately equal to a gap dimension d4 between the first and second electrodes 114, 118. In the example of FIGS. 1A and 1B, the seal layer 128 can also define a lateral dimension d1 of the sealed chamber 116.

In the example of FIGS. 1A and 1B, each of the first and second electrodes 114, 118 is shown to have a thickness of d5. In some embodiments, an emissive coating can be provided on the sealed chamber surface of each of the first and second electrodes 114, 118. For example, and as shown in FIG. 1B, an emissive coating 124 can be provided for the first electrode 114, and an emissive coating 126 can be provided for the second electrode 118.

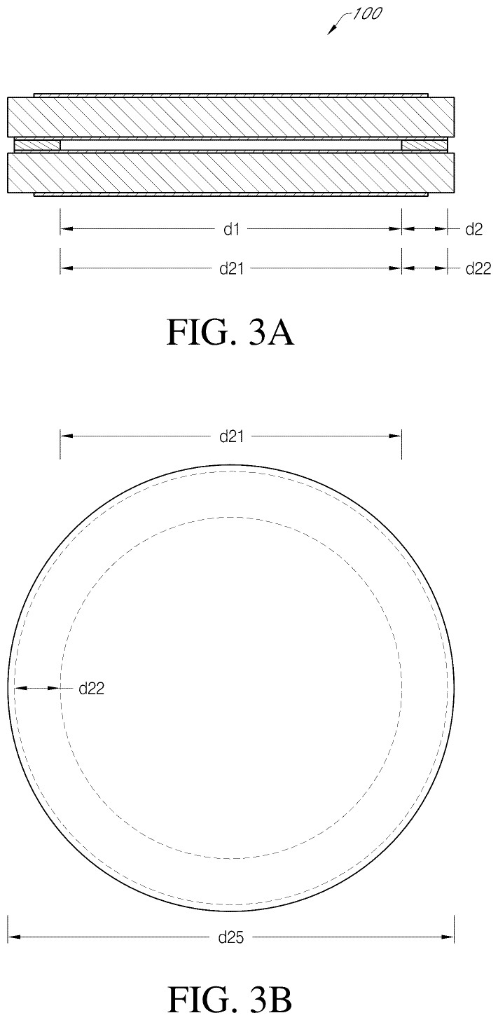

FIGS. 2A and 2B show that in some embodiments, the MOV/GDT device 100 of FIGS. 1A and 1B can have a rectangular lateral shape having an overall length dimension d15 and an overall width dimension d15′. It will be understood that such a rectangular lateral shape can include a square shape and a non-square shape.

In the rectangular shaped MOV/GDT device 100 of FIGS. 2A and 2B, a sealed chamber (116 in FIG. 1A) can also have a rectangular lateral shape, such that the lateral dimension d1 in FIG. 1A can be a length dimension d11 in FIGS. 2A and 2B. In such a configuration, a width dimension of the rectangular shaped sealed chamber is indicated as d11′.

In the rectangular shaped MOV/GDT device 100 of FIGS. 2A and 2B, the foregoing rectangular shaped sealed chamber can be defined by a rectangular shaped boundary of a seal layer, such as a glass seal layer, (128 in FIGS. 1A and 1B) having a lateral width dimension d12 (d2 in FIG. 1B). In the example of FIG. 2B, the lateral width dimension (d12) of the glass seal layer along the length of the MOV/GDT device 100 is depicted to be the same as the lateral width dimension (d12) along the width of the MOV/GDT device 100. However, it will be understood that the lateral width dimension of the glass seal layer along the length of the MOV/GDT device 100 may or may not be the same as the lateral width dimension along the width of the MOV/GDT device 100.

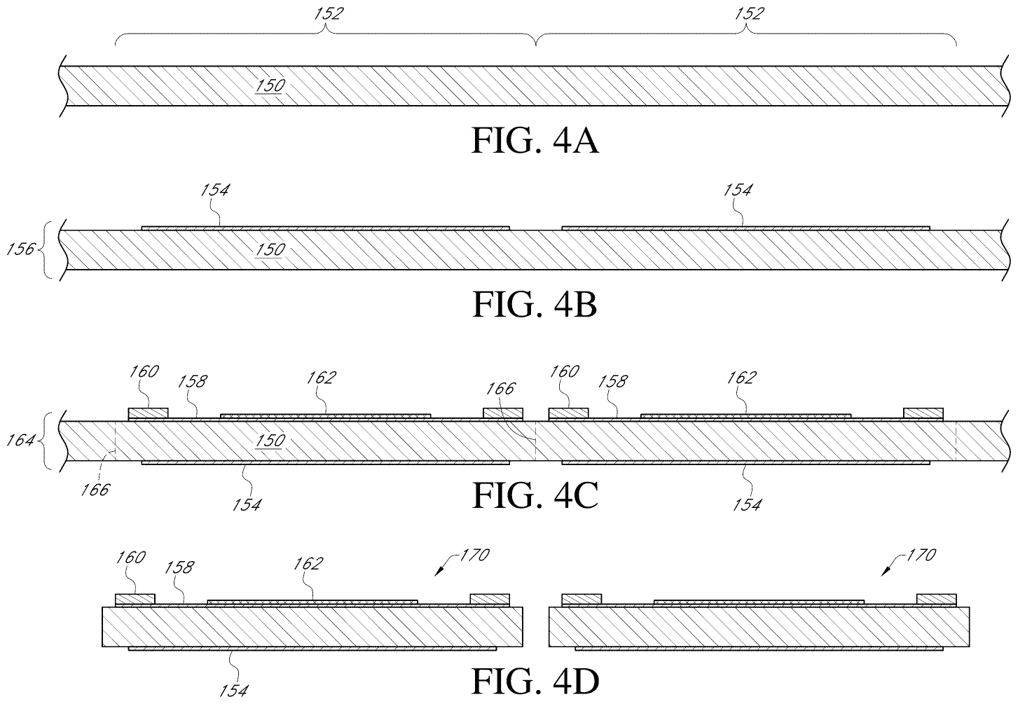

FIGS. 3A and 3B show that in some embodiments, the MOV/GDT device 100 of FIGS. 1A and 1B can have a circular lateral shape having an overall diameter dimension d25. In the circular shaped MOV/GDT device 100 of FIGS. 3A and 3B, a sealed chamber (116 in FIG. 1A) can also have a circular lateral shape, such that the lateral dimension d1 in FIG. 1A can be a diameter dimension d21 in FIGS. 3A and 3B.

In the circular shaped MOV/GDT device 100 of FIGS. 3A and 3B, the foregoing circular shaped sealed chamber can be defined by a ring shaped boundary of a seal layer, such as a glass seal layer, (128 in FIGS. 1A and 1B) having a lateral width dimension d22 (d2 in FIG. 1B).

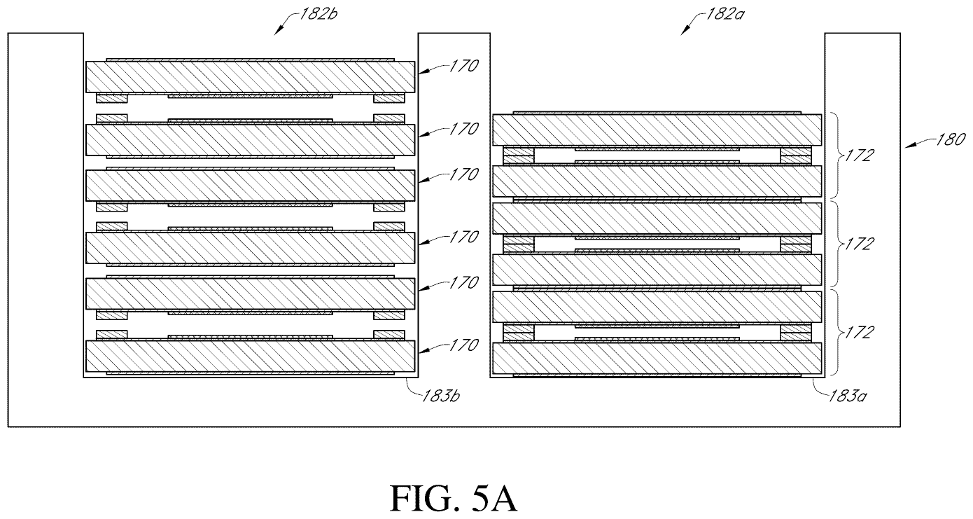

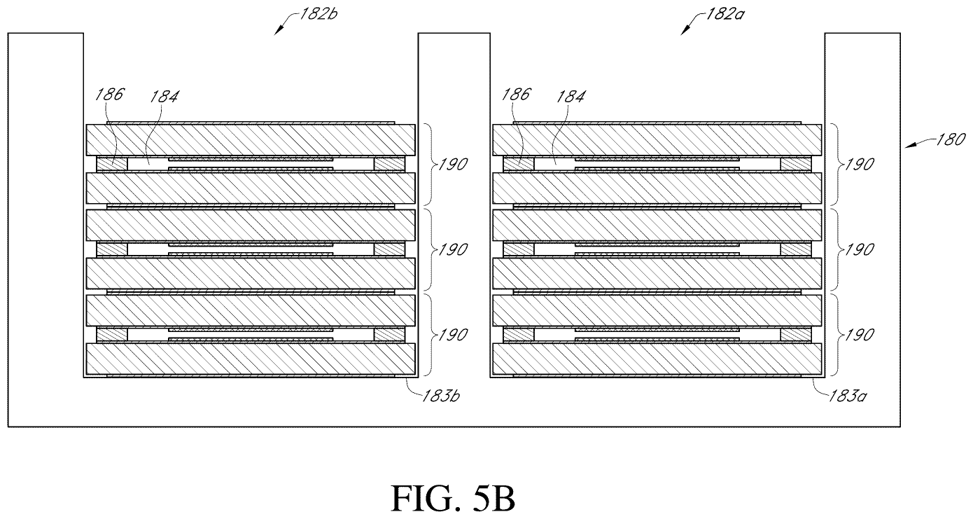

FIGS. 4A to 4D and FIGS. 5A to 5C show examples of how MOV/GDT devices having one or more features as described herein can be manufactured to provide a desired discharge voltage (e.g., a desired low discharge voltage) property of the GDT portion. In FIGS. 4A to 4D, such a manufacturing process can include process steps that are performed while a plurality of units are attached in an array format. In FIGS. 5A to 5C, the manufacturing process can include process steps where one or more stacks of the units produced in the process steps of FIG. 4A to 4D can be utilized to yield a plurality of MOV/GDT devices.

FIG. 4A shows a process step where a plate of metal oxide 150 can be provided or formed. Such a plate is shown to include a plurality of units 152 where each unit will eventually become part of a respective MOV/GDT device.

In a process step of FIG. 4B, an electrode 154 can be formed on the metal oxide 150 for each unit 152, so as to form an assembly 156. In some embodiments, each of such electrodes can become an external electrode (e.g., 110 or 122 in FIG. 1A) of a respective MOV/GDT device.

In a process step of FIG. 4C, an electrode 158 can be formed on the metal oxide 150 on the opposite side from the electrode 154 for each unit 152. In some embodiments, each of such electrodes can become an internal electrode (e.g., 114 or 118 in FIG. 1A) for the GDT portion of a respective MOV/GDT device.

The process step of FIG. 4C is shown to further include a layer 160 of sealing material formed at or near the perimeter portion of each unit 152, so as to form an assembly 164. In some embodiments, each of such sealing layers 160 can be formed from an electrically insulating material such as an insulative sealing glass or other high temperature insulative sealing material. In some embodiments, the sealing layer 160 can be dimensioned to provide one or more functionalities described herein, including providing a desired gap dimension (e.g., d4 in FIG. 1B) in the respective MOV/GDT device.

In some embodiments, the assembly 164 of FIG. 4C can further include an emissive coating 162 formed on a laterally inner portion of the corresponding electrode 158. It will be understood that in some embodiments, the emissive coating 162 may or may not be the utilized.

In a process step of FIG. 4D, the assembly 164 of FIG. 4C can be singulated (e.g., along singulation lines 166), so as to yield a plurality of individual units 170.

FIGS. 5A to 5C show an example of how a plurality of individual units 170 of FIG. 4D can be assembled to form one or more MOV/GDT devices.

FIG. 5A shows that in some embodiments, one or more pairs of individual units 170 of FIG. 4D can be stacked in an apparatus 180. More particularly, the example apparatus 180 of FIG. 5A is shown to include two stacking receptacles 182a, 182b, with each stacking receptacle dimensioned to receive one or more pairs 172 of individual units 170. Each stacking receptacle (182a or 182b) is shown to include a floor (183a or 183b). It will be understood that the apparatus 180 can include more or less number of stacking receptacle(s) than the example number of two in FIG. 5A.

Each pair 172 of individual units 170 is shown to include two individual units 170 oriented so that their sides with the respective sealing layers (160 in FIG. 4D) face each other. In the first stacking receptacle 182a, three pairs of individual units 170 are shown to be stacked already. In the second stacking receptacle 182b, the same number of pairs of individual units 170 are shown to be in the process of being placed into the receptacle 182b.

Once the stacking process is completed to be similar to the stack in the first receptacle 182a, the apparatus 180 can provide a desired gas (e.g., inert gas, active gas, or some combination thereof) so that the unsealed chamber of each pair of units 170 becomes filled with the gas. Then, as shown in FIG. 5B, the stacks can be heated so that the sealing layers (160 in FIG. 4D) of each pair of units 170 fuse to form a fused unit 190 with a respective seal 186 and a sealed chamber 184 with the desired gas therein.

FIG. 5C shows that once the stacks cool from the heating process, each fused unit 190 can be removed from the respective receptacle to be a MOV/GDT device 100 having one or more features as described herein.

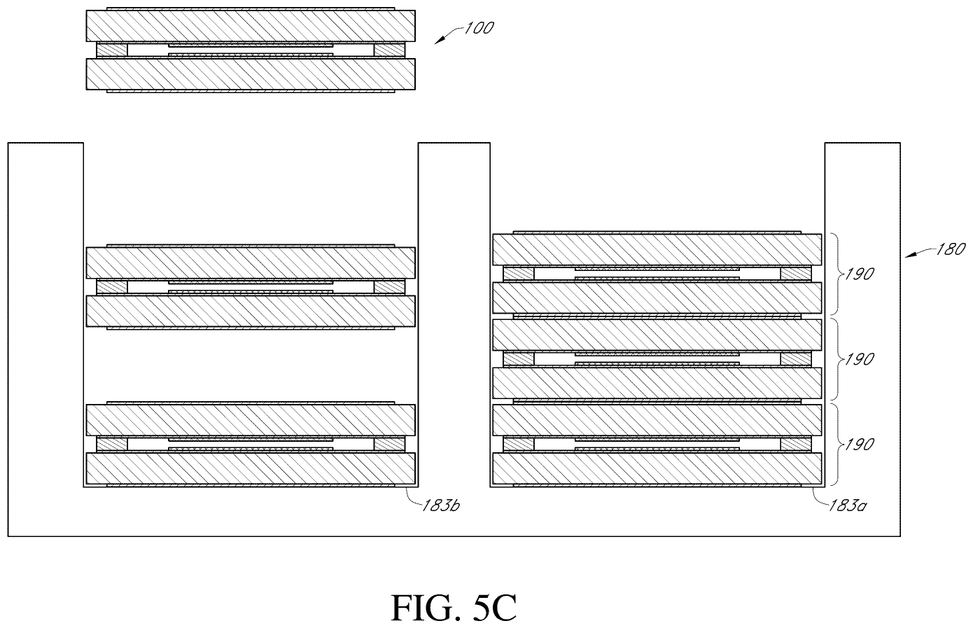

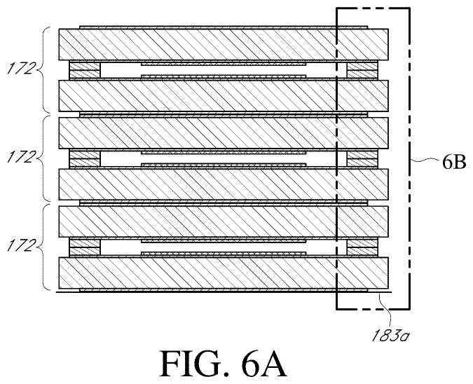

FIGS. 6 to 8 show examples of how a plurality of MOV/GDT devices having one or more features as described herein can be formed with the stacked configuration of FIGS. 5A to 5C. FIG. 6A shows a stack having a plurality of un-sealed pairs 172 prior to a sealing process, where each pair has two individual units (170 in FIG. 5A) oriented so that their sides with the respective sealing layers (160 in FIG. 4D) face each other, similar to the example of FIG. 5A. Such a stack of pairs 172 are shown to be supported by a floor 183 (e.g., a floor 183a of a stacking receptacle 182a in FIG. 5A).

FIG. 6B shows an enlarged view of one side of the stack of FIG. 6A. In the enlarged view, each of the three example pairs is indicated as 172, with each pair having dimensions d31 for a first external electrode (154 in FIG. 4D), d32 for a first MOV layer (150 in FIG. 4C), d33 for a first internal electrode (158 in FIG. 4D), d34 for a first sealing layer (160 in FIG. 4D), d34 for a second sealing layer (160 in FIG. 4D), d33 for a second internal electrode (158 in FIG. 4D), d32 for a second MOV layer (150 in FIG. 4C), and d31 for a second external electrode (154 in FIG. 4D). Accordingly, the overall height of the 3-pair stack in FIG. 6B is approximately 3×(d31+d32+d33+d34+d34+d33+d32+d31) from the floor 183, when the pairs of the stack are in an un-sealed state.

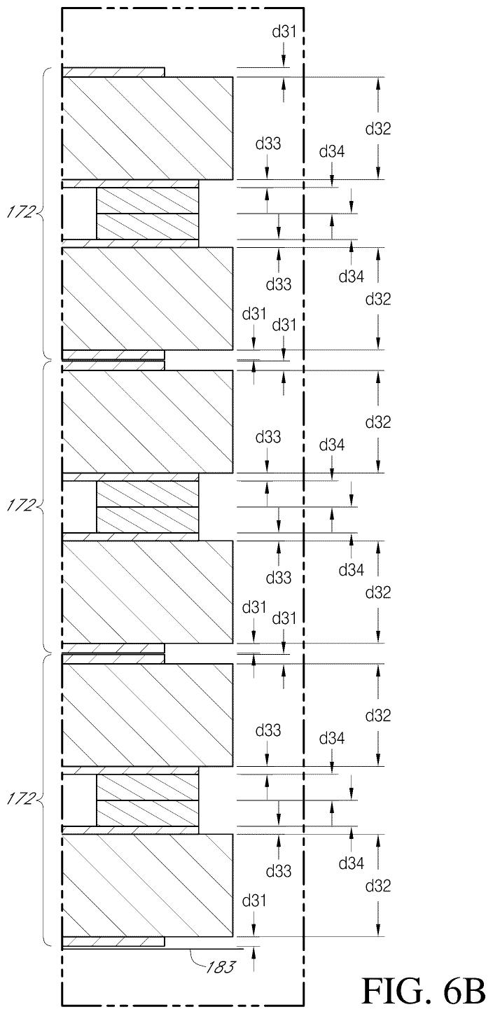

FIG. 7 shows that in some embodiments, a selected force F (indicated as an arrow 173) can be applied on the top of the stack of pairs 172 in an un-sealed state. Such a force can allow the stack of un-sealed pairs 172 to remain as a stack on the floor 183 as a sealing process is introduced.

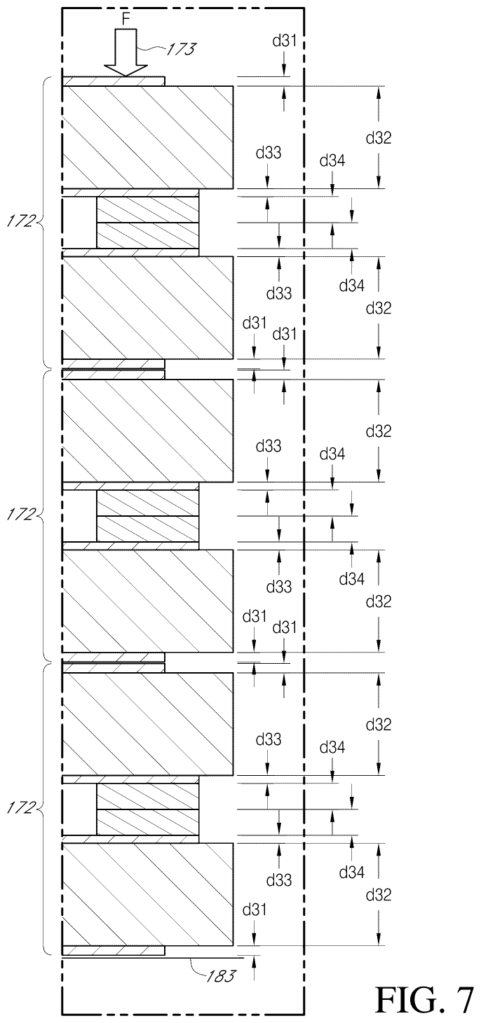

FIG. 8 shows that in some embodiments, a force F (indicated as an arrow 173) can be applied on top of the stack of pairs during a sealing process to yield a stack of sealed pairs 190, with each pair including a seal layer (128 in FIG. 1B) with a thickness dimension of d3 resulting from fusing of the two sealing layers (160 in FIG. 4D, with each having a thickness dimension of d34 in FIG. 7). It is noted that during the sealing process under the force F, the fusing of the two sealing layers may result in the sealing layer to have its thickness reduced from the thickness of the two un-fused sealing layers (i.e., 2×d34). Thus, by providing an appropriate force F before and/or during the sealing process, a desired thickness value of d3 in FIG. 8 can be obtained, since the fusing of the two sealing layers melt and fuse with mechanical properties including pliable mechanical property of the fusing layers. As described herein, such a thickness value of the seal layer generally provides a gap dimension between the two internal electrodes facing each other in the respective GDT.

In some embodiments, the force F in the example of FIG. 7 (prior to the sealing process) and the force F in the example of FIG. 8 (during the sealing process) may or may not be the same. In some embodiments, the force in the example of FIG. 8 (during the sealing process) may be a constant force, a time-varying force, or some combination thereof.

Referring to FIGS. 5 to 8, it is noted that in some embodiments, a desired thickness dimension (d3 in FIG. 8) of a seal (186 in FIG. 5B) of each MOV/GDT device can be provided by implementation of some or all of, for example, (1) accurate control of printing of glass (e.g., when the seal is a glass seal) to obtain uniform amounts of glass with respect to surface area of the inner electrodes covered and the total volume of the glass, and (2) amount of force applied to a stack (e.g., force 173 in FIG. 8) during a sealing process.

In the various examples described in reference to FIGS. 1 to 8, each MOV/GDT device 100 is depicted as having flat external electrodes (e.g., 110 and 122 in FIG. 1A) formed on respective flat external surfaces of metal oxide layers (e.g., 112 and 120 in FIG. 1A). In some embodiments, a MOV/GDT device can include non-flat external surfaces of metal oxide layers and respective non-flat external electrodes.

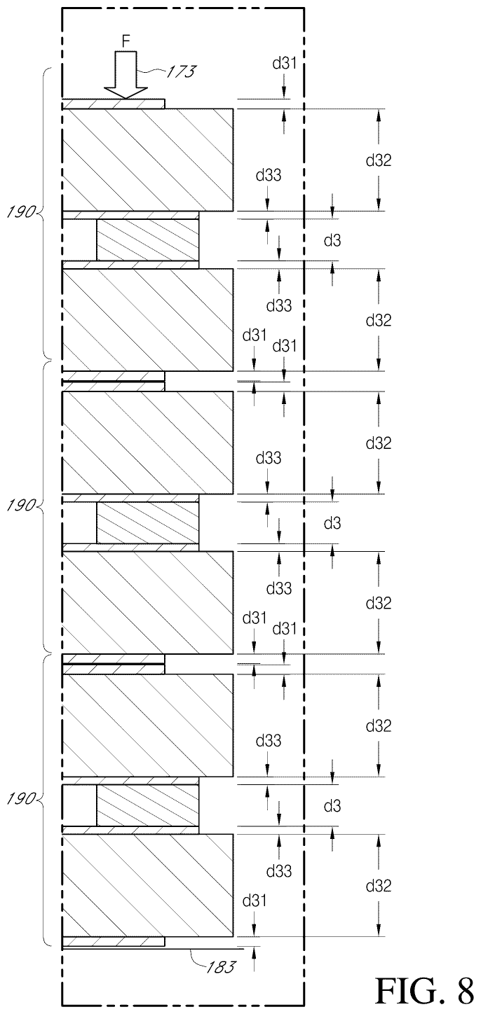

For example, FIG. 9 shows a MOV/GDT device 100 having a GDT portion 104 that is similar to the MOV/GDT device 100 of FIG. 1A. For the MOV/GDT device 100 of FIG. 9, however, a first metal oxide layer 112 is shown to include a non-flat external surface to accommodate a first external electrode 110 having a flared edge configuration. Similarly, a second metal oxide layer 120 is shown to include a non-flat external surface to accommodate a second external electrode 122 having a flared edge configuration. Additional details concerning MOVs having one or more flared-edge electrodes can be found in the above-referenced International Publication No. WO 2021/174140A1.

In the example of FIG. 9, the GDT portion 104 of the MOV/GDT device 100 can be similar to the example of FIG. 1A. Accordingly, a seal portion 130 of the MOV/GDT device 100 of FIG. 9 can be similar to the seal portion 130 of the MOV/GDT device 100 of FIGS. 1A and 1B. It will be understood that a gap dimension (d4 in FIG. 1B) between the two internal electrodes (114, 118 in FIG. 1B) provided by a selected thickness of the seal layer (128 in FIG. 1B) may or may not be the same between MOV/GDT devices 100 of FIG. 1A and FIG. 9.

In some embodiments, MOV/GDT devices 100 of FIG. 9 can be fabricated similar to the examples described herein in reference to FIGS. 4 to 8. In some embodiments, an additional process step of forming a depression for each unit on a surface of a plate of metal oxide (150 in FIG. 4A) can be achieved as described in the above-referenced International Publication No. WO 2021/174140A1.

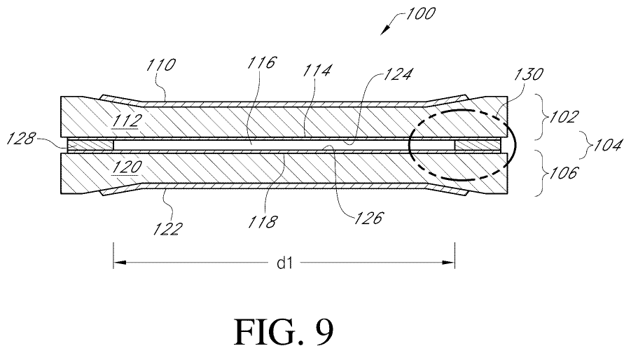

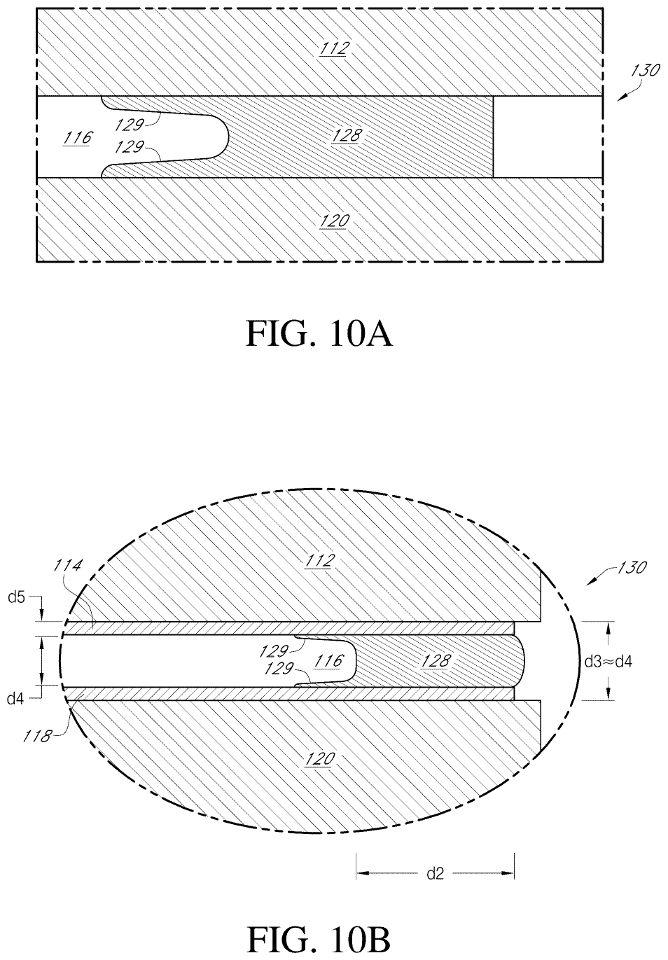

FIG. 10A shows a line-drawing depiction of a photograph of a sectional view of a seal portion 130 of a MOV/GDT device having one or more features as described herein. FIG. 10B depicts the seal portion 130 of FIG. 10A, but with various dimensions similar to the example seal portion of FIG. 1B.

FIGS. 10A and 10B show that in some embodiments, a seal layer 128 that provides a thickness dimension of d3 to form a desired gap dimension d4 between opposing electrodes 114, 118 of a sealed chamber 116 can include a laterally extending portion 129 formed to cover a portion of each of either or both of the electrodes 114, 118. In the example of FIGS. 10A and 10B, such an extending portion of the seal layer 128 is shown to cover a portion of each of both of the electrodes 114, 118. In the example of FIG. 10B, each of the first and second electrodes 114, 118 is shown to have a thickness of d5.

In some embodiments, such seal extensions can be desirable to increase length of leakage path to reduce leakage of current between the two electrodes 114, 118. Additional details concerning such seal extensions can be found in the above-referenced International Publication No. WO 2021/174140A1.

In the various examples described herein, a pair of individual units (e.g., a pair 172 of individual units 170 in FIG. 5A) that is processed to form a MOV/GDT device, is assumed to include two identical individual units that are oriented so that their sides with internal electrodes (158 in FIG. 4D) and sealing layers (160 in FIG. 4D) face each other. However, it will be understood that in some embodiments, two individual units that form a pair do not necessarily need to be the same to form a MOV/GDT device having one or more features as described herein.

For example, one of the individual unit can have a sealing layer that has a pre-sealing thickness that is different than a sealing layer of the other individual unit. Such different-thickness values of the sealing layers can be selected so that when the pair is sealed, the resulting seal provides desirable dimensions including thickness.

In another example, one of the individual unit can have a sealing layer while the other individual unit does not prior to a sealing operation. Such a sealing layer on one of the individual units can have a selected thickness value so that when the pair is sealed, the resulting seal provides desirable dimensions including thickness.

In an experiment, various configurations of MOV/GDT devices having low voltage GDT functionality were tested. In such MOV/GDT devices, a gap in GDT electrodes are provided by the thickness of glass seals, allowing for reduced device sizes and lower voltages. Neon and argon gases were tested to provide low voltage functionality. In addition, chemistry of emissive coating (e.g., glass coating and active coating) was varied to provide and/or facilitate low voltage functionality. In some embodiments, the foregoing active coating can be configured to provide a substantially uniform and repeatable breakdown voltage at a selected level.

As a control configuration, a MOV/GDT device included a glass emissive coating, and argon was used as a GDT gas. Varying both the emissive coating type and gas type, a MOV/GDT device having neon gas (e.g., at approximately 500 torr) and active emissive coating was expected to have the lowest breakdown GDT voltage among different combinations of neon/argon and glass coating/active coating.

It was found that having a selected gap dimension provided by the thickness of glass seal resulted in the breakdown GDT voltage being lowered regardless of the gas type and coating type. It was also found that a combination of neon gas and active coating resulted in a distribution of very low values of breakdown GDT voltage, at about 90V. In some embodiments, such an active coating can include one or more alkali metals such as cesium and sodium, one or more compounds based on alkali metals, or some combination thereof. Such a distribution of very low values of breakdown GDT voltage may be more effective because the combination provided the least amount or reduced amount of energy to trigger activation of alkaline elements and/or compounds.

In some embodiments, a MOV/GDT device having one or more features as described herein includes a flat arrangement of internal electrodes, thereby providing a capacitance that is similar to a parallel plate capacitance that depends only on gap dimension which is provided by the thickness of the seal (e.g., glass seal). Thus, capacitance property of such a MOV/GDT device can be increased by increasing the seal thickness, and decreased by decreasing the seal thickness.

In an example MOV/GDT device, a gap distance of approximately 280 μm was provided between the two internal electrodes having active emissive coatings. Neon gas at approximately 500 torr was provided in the resulting sealed chamber. In a sample size of 140, such MOV/GDT devices provided an average GDT breakdown voltage of approximately 111V before conditioning, and approximately 95V after conditioning.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Description using the singular or plural number may also include the plural or singular number respectively. The word “or” in reference to a list of two or more items, that word covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

While some embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

1. A method for manufacturing a plurality of electrical devices, the method comprising:
forming or providing a number of metal oxide varistors (MOVs) such that each MOV includes an external electrode on a first side of a metal oxide layer and an internal electrode on a second side of the metal oxide layer;
forming a layer of sealing material at or near a perimeter of the second side of the metal oxide layer of each MOV;
forming a stack having one or more pairs, each pair including two MOVs with their second sides facing each other such that the respective layers of sealing material engage each other; and
performing a sealing operation to fuse the engaged layers of sealing material to result in a seal that provides a sealed chamber of a gas discharge tube (GDT) between the two internal electrodes of each pair, the sealing operation performed such that the seal has a thickness dimension that is approximately same as a selected gap dimension between the two internal electrodes.

2. The method of claim 1, wherein the forming of the layer of sealing material results in a thickness of the layer of sealing material of one of the two MOVs of each pair being substantially same as a thickness of the layer of sealing material of the other of the two MOVs of the pair.

3. The method of claim 1, wherein the sealing material includes glass or other high temperature insulative sealing material.

4. The method of claim 1, wherein the forming or providing of MOVs results in the external electrode of each MOV being substantially flat.

5. The method of claim 1, wherein the forming or providing of MOVs results in the external electrode of each MOV having a flared edge configuration.

6. The method of claim 1, wherein the stack includes a plurality of pairs.

7. The method of claim 1, wherein the performing of the sealing operation includes providing a desired gas to the stack so that the desired gas is introduced to an unsealed chamber of each pair of MOVs.

8. The method of claim 7, wherein the desired gas includes an inert gas and/or an active gas.

9. The method of claim 7, wherein the desired gas includes neon or argon.

10. The method of claim 9, wherein the desired gas includes neon at approximately 500 torr.

11. The method of claim 7, further comprising forming an emissive coating on each internal electrode.

12. The method of claim 11, wherein the emissive coating includes glass or an active coating.

13. The method of claim 12, wherein the emissive coating includes the active coating.

14. The method of claim 13, wherein the active coating includes an alkali metal or alkali-based compound.

15. The method of claim 11, wherein the gap dimension between the two internal electrodes, the emissive coating and the desired gas are selected to provide a breakdown voltage of the GDT that is less than 120V.

16. The method of claim 11, wherein the breakdown voltage of the GDT is less than 100V.

17. The method of claim 7, wherein the selected gap dimension between the two internal electrodes is less than 500 μm.

18. (canceled)

19. (canceled)

20. (canceled)

21. (canceled)

22. The method of claim 1, wherein the sealing operation includes providing a selected force on the stack to result in the thickness dimension of the seal of each pair.

23. A system for manufacturing a plurality of electrical devices, the system comprising:
a metal oxide varistor (MOV) fabrication system configured to form or provide a number of MOVs such that each MOV includes an external electrode on a first side of a metal oxide layer and an internal electrode on a second side of the metal oxide layer;
a gas discharge tube (GDT) fabrication system configured to form a layer of sealing material at or near a perimeter of the second side of the metal oxide layer of each MOV, the GDT fabrication system further configured to form a stack having one or more pairs, each pair including two MOVs with their second sides facing each other such that the respective layers of sealing material engage each other, the GDT fabrication system further configured perform a sealing operation to fuse the engaged layers of sealing material to result in a seal that provides a sealed chamber of a GDT between the two internal electrodes of each pair, such that the seal has a thickness dimension that is approximately same as a selected gap dimension between the two internal electrodes.

24. An electrical device comprising:
first and second metal oxide varistors (MOVs), each MOV including an external electrode on a first side of a respective metal oxide layer and an internal electrode on a second side of the metal oxide layer; and
a seal at or near a perimeter of the second side of the metal oxide layer of each of the first and second MOVs to thereby provide a sealed chamber with a desired gas therein of a gas discharge tube (GDT) between the two internal electrodes of the first and second MOVs, the seal having a thickness dimension that is approximately same as a selected gap dimension between the two internal electrodes.

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)
